(19) United States
(12) Patent Application Publication
(10) Pub. No.: US 2019/0141913 A1
(43) Pub. Date: May 16, 2019

(54) Leaf and lawn debris removal apparutus

(71) Applicant: Martha E. Carlton, Livonia, MI (US)

(72) Inventor: Martha E. Carlton, Livonia, MI (US)

(21) Appl. No.: 15/732,439

(22) Filed: Nov. 13, 2017

(51) Int. Cl. A01G 20/43; A01D 7/10; A01B 1/20; B62B 3/02; B62B 1/12; A46B 5/00

(52) U.S. Cl. CPC A01G 20/43; A01D 7/10; A46B 5/00; B62B 3/02; B62B 1/12; A01B 1/20

(57) ABSTRACT

A leaf removal apparatus designed to safely and efficiently remove leaves, twigs and other debris from lawns. When pushed independently or mounted flush with the front facing blade of a lightweight snow shovel, long pole, or other long pole tool, the apparatus can be used by a person walking behind the device and pushing it in a snow plowing motion eliminating the need for raking and saving time. It may be formed of cardboard, plastic, lightweight metal, screen or other appropriate material. This apparatus is a one-piece device comprised of a flat or pouched gathering area with each side curved or folded inward to hold in the leaves and other yard waste. The apparatus may be attached to the long pole device, most appropriately to a snow shovel, with slots, brackets, tape, hooks, Velco, clips, straps, ties or other suitable attachment methods. The apparatus may be varying height and width. When pushing the device in a snow plowing motion, leaves are pushed upward and forward removing debris from the lawn and depositing into large piles for disposal.

### TECHNICAL FIELD

The present invention relates to lawn rakes, and more particularly relates to an improved push rake/leaf plow for quickly and easily removing large volumes of leaves and similar debris from a lawn or other relatively flat outdoor area.

### BACKGROUND

The annual raking and disposal of fallen tree leaves requires one to cover large areas with a rake, collecting the leaves into piles for disposal. This process can be time consuming and labor intensive often resulting in blistered hands. Although leaf blowing has become a more common practice it is still time consuming and noisy.

Accordingly, there is a need for a means by which one can gather large volumes of leaves into a pile in a quicker, less labor-intensive manner.

The lawn raking implement background art is replete with efforts by inventors to create new and improved devices for easily removing a large volume of leaves and debris from a yard. There exist patents for leaf plowing attachments for riding lawn mowers, as well as for tined push rakes which do not allow for a simple sweeping motion to move the leaves forward into a pile. There exist patents for a several modified snow shovel tools for moving leaves and other debris. The inventor's research has not produced evidence that a patent exists for a very lightweight apparatus that can be mounted onto an existing snow shovel, is removable, and is an effective method to push rake/leaf plow large volumes of leaves.

### DISCLOSURE OF THE INVENTION

In accordance with the present invention, the applicant provides an improved push rake/leaf plow for leaves and the like comprised of corrugated plastic, molded plastic, cardboard, framed fabric, lightweight metal, paper, screen or other appropriate material. This apparatus is a one-piece modified rectangular device comprised of a flat or pouched gathering area with sides curved or folded inward to hold in the leaves and other yard waste. Alternately, the apparatus may be completely flat or may have one flat end and one curved/folded end. The apparatus is attached to the long pole tool, most appropriately to a snow shovel, by an attaching apparatus comprising a series of slots fabricated in the device and elastic straps with hooks that are adjustable for various snow shovel/long pole tool heights and widths. The attaching apparatus may alternately be constructed of tape, Velcro, clips, or other appropriate fasteners. The apparatus itself may be varying height and width and may mount various standard size snow shovels or other long pole tools. When pushing the mounted apparatus in a plowing motion, leaves are pushed upward and forward removing debris from the yard and depositing into large piles for disposal.

It is therefore the object of the present invention to provide a lightweight time-saving push rake/leaf plow which may be easily pushed forward to accumulate and quickly move large volumes of leaves from a ground surface area.

Another object of the present invention is to provide a push rake/leaf plow which may be easily and efficiently manufactured and marketed.

Another object of the present invention is to provide a push rake/leaf plow which is of durable and reliable constructions.

A further object of the present invention is to provide a cost-effective means to increase utilization of existing long pole tools or snow shovels by providing an add-on apparatus thus creating a push rake/leaf plow.

A further object of the present invention is to provide a push rake/leaf plow which utilizes an existing long pole tool or snow shovel that is lightweight, can move large volumes of leaves, and is able to utilize the existing snow shovel upon which the apparatus is mounted to absorb any friction impact to the device so there is little wear and tear on the attached apparatus.

A further object of the present invention is to provide a push rake/leaf plow which is lightweight and simple in construction and yet able to effectively remove large volumes of leaves from a yard area without the labor and manual dexterity requirements of a conventional rake thus reducing friction blisters on the hands.

A further object of the present invention is to provide a push rake/leaf plow which will eliminate the operating and maintenance expense and noise associated with leaf blowers or other motorized equipment.

A further object of the present invention is to provide a push rake/leaf plow which is capable of gathering leaves and other debris from trees which are difficult to rake such as sycamore trees and others.

Still a further object of the present invention is to provide a push rake/leaf plow which may be removed from the long pole tool or snow shovel and stored in a space saving manner; for instance hanging flat against a wall.

Some of the objects of the invention having been stated, other objects will become evident as the description proceeds, when taken in connection with the accompanying drawing

### BACKGROUND ART

Numerous inventors have attempted to devise manual push rake/leaf plow devices for bulk leaf removal. The prior background art discloses various rakes that are comprised of tines, shovel-like devices, shovel and rake/broom combination devices, and riding lawn mower attachments. The search for prior art did not disclose any patents that read directly on the claims of the invention; however, the following references were considered related:

For example in the field of push rakes:

U.S. Pat. No. 2,545,226A to Charles J. Claude presents a leaf scoop which may be pushed over the surface of the ground in the manner of a snow shovel

U.S. Pat. No. 656,093 A to John Irving Caruthers presents a lawn sweeper comprised of a handle and a blade that is pushed over the surface of the ground.

U.S. Pat. No. 4,888,942 A to Anthony Monaco presents a labor saving lawn implement comprising a blade with a flat planar surface and a long pole handle for pushing leaves.

U.S. Pat. No. 20100263346A1 to Wesley Westgarde presents a debris collector comprised of a shaft, a scoop implement, and a frame holding the scoop.

U.S. Pat. No. 20040178646A1 to Gerald Root and Robert Panasiuk presents an apparatus to assist in the collection of debris distributed over the ground. In one embodiment the apparatus comprises a hopper and a handle secured to the hopper.

U.S. Pat. No. 2,887,337A to Rene J. F. J Begue presents a garden implement for leaf raking comprised of a shovel with a deflector.

U. S. Pat. No. 20110219740 A to Feras Najeh Abughazaleh presents a lawn rake attachment and rake for small debris

U.S. Pat. No 20080309105 to Eric Hayner presents a material handling tool adapted for pushing different types of material along a surface. The handle may be removed for attachment to a riding lawn mower.

U.S. Pat. No. 4,970,853 A to Jesse M. Greene III presents a push rake having a handle member with a transverse frame secured to one end for carrying a plurality of tines.

U.S. Pat. No. 5,918,920A to William C. Tamburro Sr. presents a combination rake and shovel tool.

U.S. Pat. No. 7,617,666 B1 to Vincenzo Marchese presents an apparatus to assist in the collection of lawn debris comprising a flat section of tines with a groove to receive a shovel.

For example in the field of push rake/leaf plow attachments for lawn mowers:

U.S. Pat. No. 4,987,731 A to Vito Cianciulli and Michael A. Cianciulli presents a leaf raking attachment for a conventional push mower.

U.S. Pat. No. 6,308,505 B1 to James Beckett presents a leaf raking attachment for a riding lawn mower.

Also of interest is the relatively recent development use of lightweight plastic in leaf gathering and disposal. The background art discloses numerous inventions none of which are used as a push rake/leaf plow.

For example in the field of leaf gathering and disposal:

U.S. Pat. No. 7,357,600 B1 to Alan M. Lew and Scott P. Davidson for a lawn debris handling system comprising a flat sheet of flexible material onto which leaves are raked and then lifted within the apparatus for disposal.

U.S. Pat. No. 6,708,74262 to Larry V. Weathers and Linda Howell Weathers presents a chute apparatus for collecting leaves into a bag for facilitating disposal.

U.S. Pat. No. 6,983,965 B1 to Aaron Bergell presents a chute apparatus for insertion into a yard waste bag of debris collection for facilitating disposal.

U.S. Pat. No. 4,470,627A to George J. Carroll and Mamie M. Carroll presents a portable leaf and trash collector comprised of a scoop and a chutes for disposing into yard waste bags.

U.S. Pat. No. 4,378,670A to Matthias M. Check and Ella L. Goodby presents a pair of concave scoops worn on a person's hands for leaf collection and disposal.

U.S. Pat. No. 5,593,117A to Claibourne N. Alexander III presents a funneled receiver for insertion into a yard waste bag for disposal.

U.S. Pat. No. 7,815,153 B2 to Nickie S. Campbell, Bobie L. Gore, Carolyn S. Gore presents a device for funneling leaves into a bag preferably used with a leaf blower.

### BRIEF LIST OF NUMBERS USED IN THE DRAWINGS

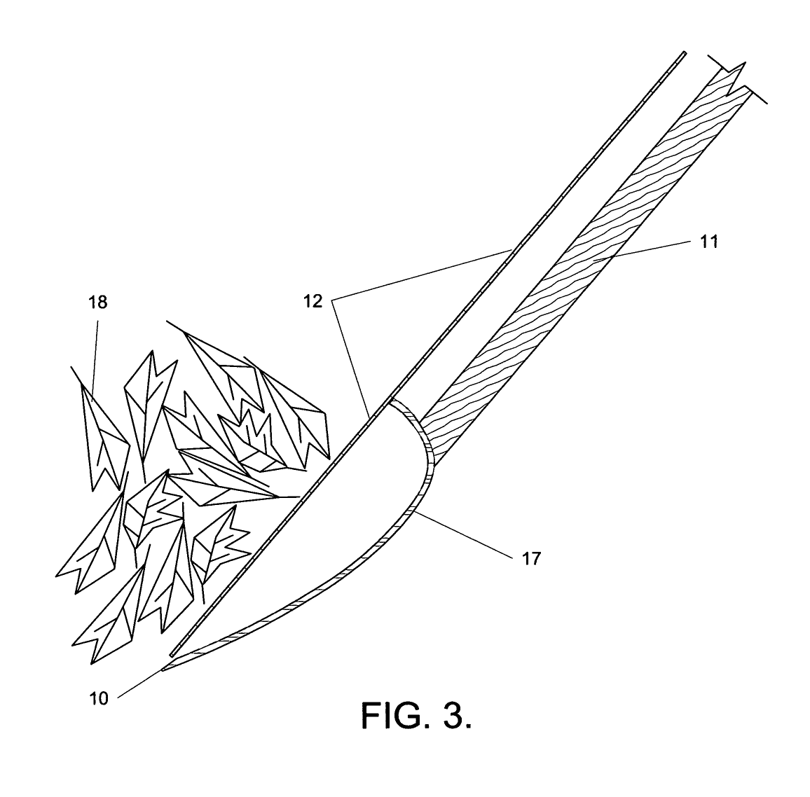

10 Leading edge of the shovel
11 Existing shovel handle
12 Collecting area of the apparatus
13 Folded panels of the apparatus
14 Slot for attachment of the apparatus to shovel
15 Aperture for ergonomic shovel handle
17 Shovel blade
18 Leaves being plowed by the apparatus
19 Elastic straps of the attachment apparatus
20 Hooks of the attachment apparatus
21 Fold lines in the apparatus
22 8″ drop design
23 1″ ground clearance
24 Aperture for handheld usage
3 Section line for cross sectional view FIG. 3

### BRIEF DESCRIPTION OF THE DRAWINGS

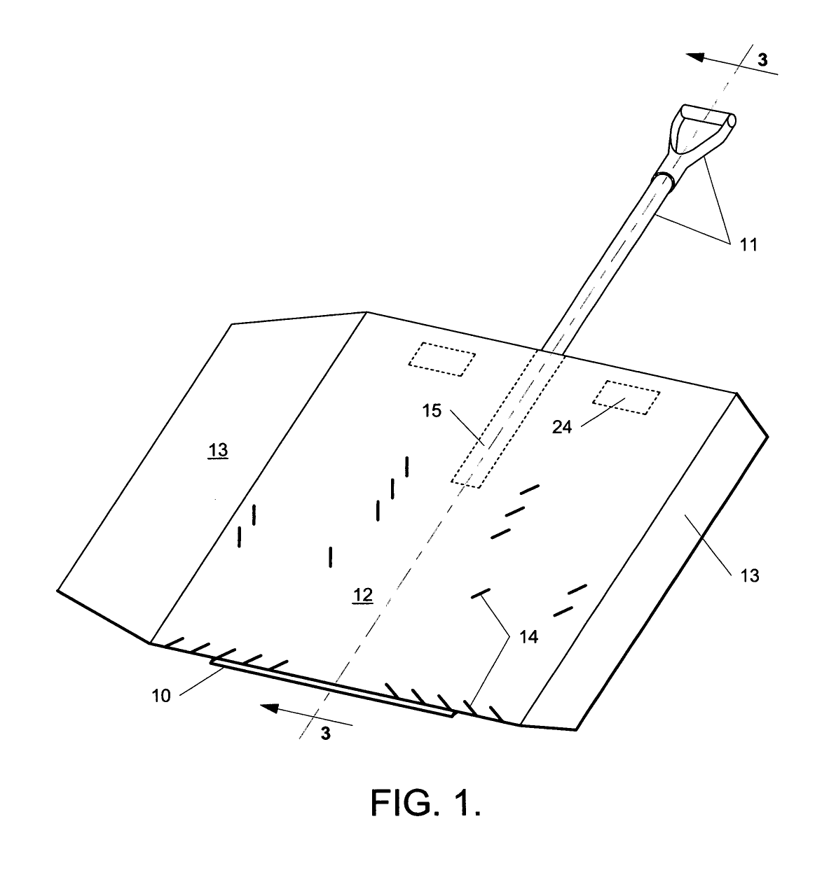

FIG. 1 is a slightly angled perspective of the front of the apparatus for leaf and lawn debris removal mounted on the front facing blade of a snow shovel in accordance with the present invention

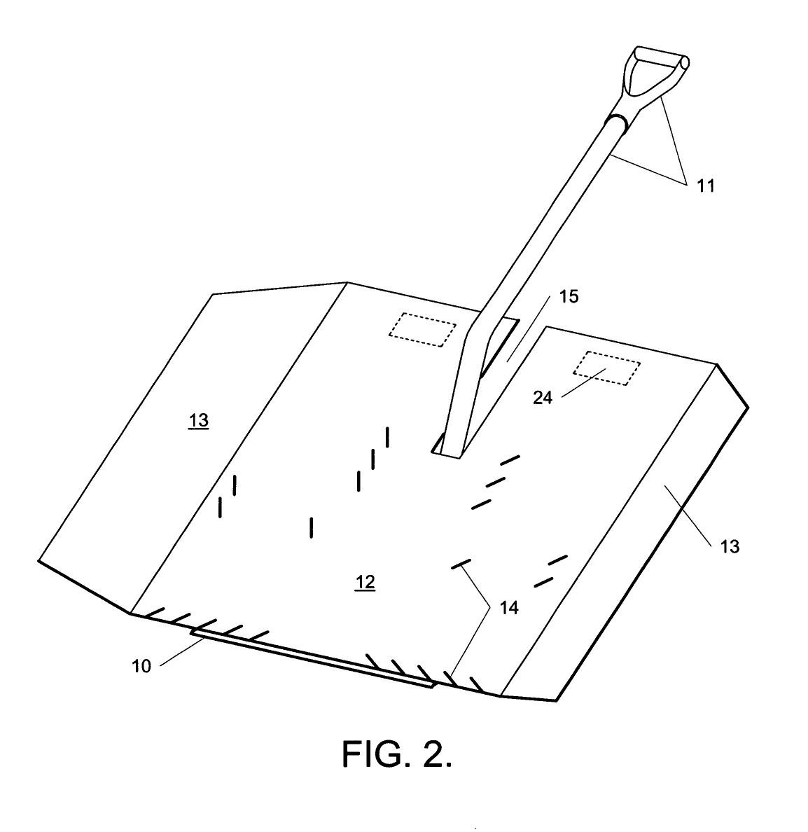

FIG. 2 is a slightly angled perspective view of the front of the apparatus for leaf and lawn debris removal mounted upon a snow shovel with an ergonomic handle in accordance with the present invention

FIG. 3 is a fragmentary vertical cross-section view showing the apparatus for leaf and lawn debris removal positioned on the blade of a snow shovel being pushed across a ground surface

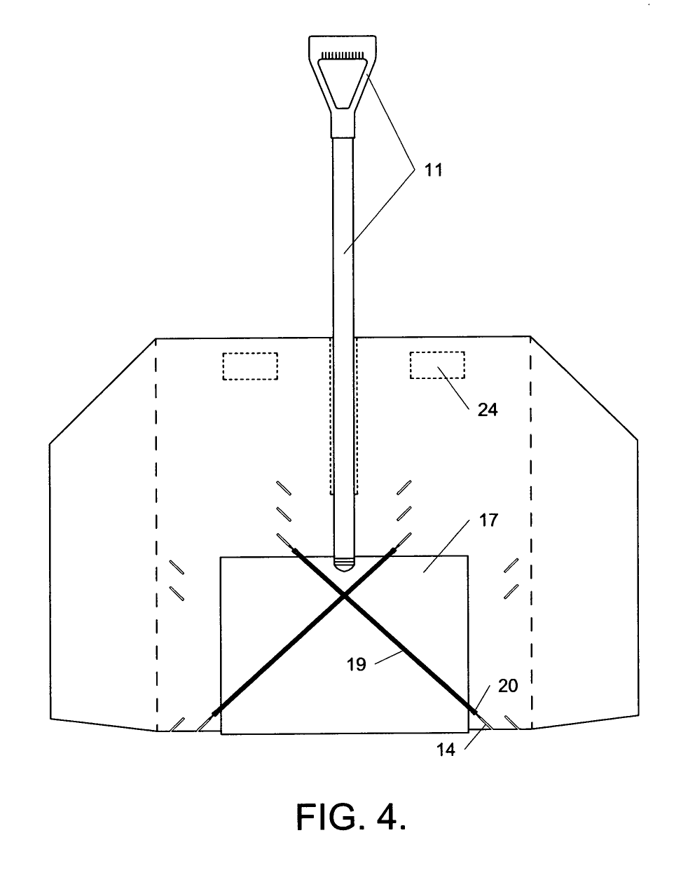

FIG. 4 is a rear elevation of the apparatus for leaf and lawn debris removal positioned on the blade of a snow shovel in accordance with the present invention

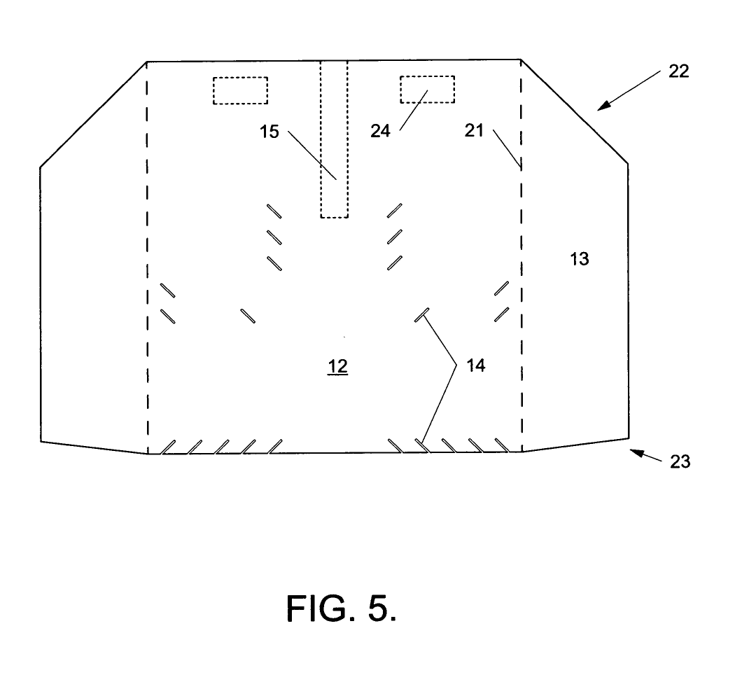

FIG. 5 is a flat view of the front of the apparatus for leaf and lawn debris removal in accordance with the present invention

### DETAILED DESCRIPTION OF THE INVENTION

In the following description, like reference characters designate like or corresponding parts throughout the various views. Also in the following description, it is to be understood that such terms as “front,” “back,” “within,” and the like are words of convenience and are not to be construed as limiting terms. Referring in more detail to the drawings, the invention will now be described. The term ‘snow shovel” is used to describe the drawings but the apparatus may be mounted upon any long pole or long pole tool.

Turning first to FIG. 1, the apparatus for leaf and lawn debris removal according to the present invention is shown in an angled front view. The apparatus for leaf and lawn debris removal is comprised of the main, flat collecting area 12, two folded side panels 13 which project forward on an angle direct leaves into the main collecting area, slots 14 for attachment onto various sized snow shovels, an aperture for hand held use 24, and an aperture to facilitate alternately mounting the apparatus for leaf and lawn debris removal 12 onto a shovel with an ergonomic handle. The apparatus for leaf and lawn debris removal has been mounted upon the leading edge 10 of a snow shovel with the handle of said snow shovel 11. A reference for a cross-sectional plane is indicated by 3.

Next, FIG. 2, the apparatus for leaf and lawn debris removal according to the present invention as in FIG. 1 with the aperture 15 removed to facilitate mounting the device upon a snow shovel with an ergonomic handle 11.

Continuing to FIG. 3, the apparatus for leaf and lawn debris removal according to the present invention as in FIG. 1 and FIG. 2 presented in a cross-sectional view on plane 3 detailed in FIG. 1. FIG. 3 demonstrates use of the apparatus for leaf and lawn debris removal with leaves 18 being pushed upward and forward by the collecting area 12 of the apparatus. The collecting area 12 of the apparatus is mounted upon the leading edge of a snow shovel blade 10, with the blade 17 of the snow shovel supporting the apparatus for leaf and lawn debris removal. The standard snow shovel handle 11 is held and the apparatus is pushed forward upon the ground and leaves 18 are deposited into a pile for disposal.

Continuing to FIG. 4, the apparatus for leaf and lawn debris removal according to the present invention is shown in a rear view. FIG. 4 demonstrates the handle of the snow shovel 11 and attached snow shovel blade 17 with the apparatus mounted to the leading edge of the snow shovel. A strap attachment system is demonstrated by slots 14, hooks 20, and straps 19 (U.S. Pat Pending 62/498,827)

Additionally FIG. 5, the apparatus for leaf and lawn debris removal according to the present invention is shown in a front view demonstrating the collecting area of the apparatus 12, the side folding panels 13, told lines in the apparatus 21, a 1″ ground clearance 23, and 8′ drop for ease folding 23, storage and viewing, aperture for an ergonomic handled snow shovel 15, aperture for hand held use of the apparatus 24, and slots 14 for attachment apparatus.

What is claimed is:

1. An apparatus for leaf and lawn debris removal being comprised of a collecting area.

2. An apparatus for leaf and lawn debris removal as described in claim 1, in which the collecting area is plastic.

3. An apparatus for leaf and lawn debris removal as described in claim 1, in which the collecting area is cardboard.

4. An apparatus for leaf and lawn debris removal as described in claim 1, in which the collecting area is metal.

5. An apparatus for leaf and lawn debris removal as described in claim 1, in which the collecting area is a screen.

6. An apparatus for leaf and lawn debris removal as described in claim 1, in which the collecting area is concave.

7. An apparatus for leaf and lawn debris removal as described in claim 1, in which the collecting area is a planar surface.

8. An apparatus for leaf and lawn debris removal as described in claim 1, in which the collecting area has folds parallel to the sides of the collecting area.
a. An apparatus for leaf and lawn debris removal as described in claim 8, in which the side panels fold forward to the collecting area forming a forward facing U-shape.

9. An apparatus for leaf and lawn debris removal that includes a collecting area and further includes handles used to propel the said apparatus in a forward motion.

10. A handle of claim 9, which is an aperture.

11. A handle of claim 9, which is a grip.

12. An apparatus for leaf and lawn debris with a collecting area capable of connection to an existing long pole tool used to propel the said apparatus in a forward motion.

13. An existing long pole tool of claim 12, which is a shovel.

14. An existing long pole tool of claim 12, which is a rake.

15. An existing long pole tool of claim 12, which is a broom.

16. An existing long pole tool of claim 12, which is a pole(s).

17. An existing long pole tool of claim 12, which is a wheeled cart.
